(19) United States
(12) Patent Application Publication
(10) Pub. No.: US 2008/0179342 A1
(43) Pub. Date: Jul. 31, 2008

(54) Fibrous material handling and feeding system

(76) Inventors: Max Lynn Woods, North Bloomfield, OH (US); Jimmy Dale Speakman, Hendersonville, TN (US); Greg Meadows, Celina, TN (US)

Correspondence Address: Robert G. Lev;Lev Intellectual Property Consulting, 4766 Michigan Blvd., Youngstown, OH, 44505, US

(21) Appl. No.: 12/004,929

(22) Filed: Dec. 21, 2007

Related U.S. Application Data
(60) Provisional application No. 60/876,717, filed on Dec. 22, 2006.

(51) Int. Cl. G07F 11/00; B23Q 7/04; G07F 11/24

(52) U.S. Cl. 221/1; 221/217; 221/277

(57) ABSTRACT

A fibrous material handling and feeding system is constituted by a casing and at least one rotating roller constituting the entire bottom of the casing. Fibers are fed directly to the top of the roller which dispenses them through spaces between the roller and the casing. It has been found that two rollers are particularly effective when dealing with polypropylene fibers.

### FIELD OF THE INVENTION

The present invention relates generally to the field of handling fiber-like materials. In particular, the present invention is directed to the handling of such materials to effect accurate measurement, handling and delivery to, for example, cementitious or concrete materials.

### BACKGROUND ART

There are potentially limitless applications for fibers, fiber-like materials, or fiber packages such as “chips”, “seeds”, “flakes”, “kernels”, “sticks”, or the like. To use any of these materials, they must be accurately measured and dispensed. This requires proper handling.

Accurately dispensing fibers or fiber packages can often be problematical due to the nature of certain types of fibrous materials and their configurations. Nonetheless, accurate handling must be done because of the precision required by the wide variety of different uses to which some fibers and fiber-like materials are put. One example is in the use of various fibers or fibrous materials as reinforcing additives for ceramics, concrete, or other cementitious mixtures.

Concrete construction is the mainstay of the world-wide building industry. The particular uses of concrete are usually determined by the strength and durability of the final concrete product. The applications to which concrete can be put are constrained because while concrete has a great deal of strength in compression, it still has poor tensile qualities. Additionally, fresh concrete can crack due to volume shrinkage and plastic shrinkage that develop during the course of concrete drying, settling and the like. The strength of the final product can be varied through the use of a wide variety of additives, as well as by other techniques. Consequently, there has been an ongoing effort on the part of structural engineers to enhance the final concrete product reducing or eliminating various limitations in the final concrete products by such means as chemical admixtures, structural reinforcement, and additives of various fibrous materials.

One of the most economical techniques has been the addition of various types of fibrous materials to cementitious and concrete mixtures to reduce and/or eliminate both early and long term cracking of the concrete, and to add other benefits (particularly strength) to the final concrete product. Various additives include fibers of cellulose, fiberglass, nylon, polypropylene, carbon, AR Glass, hybrid blends, polyester, acrylic, polyethylene, steel and any number of other fibrous materials, in a variety of different packages or configurations (such as sticks, flakes, dice, pellets, seeds, kernels, chips, or even free monofilament and multifilament fibers and similar materials). It has been found that certain types (and configurations) of fibers and fibrous materials provide greater strength than many other configurations or additives.

In particular, polypropylene fibers are extremely durable and amenable to manufacture in lengths that are particularly conducive to enhancing both early and long term properties of concrete. Further, the characteristics of polypropylene and other similar fiber materials are such as to avoid detrimental chemical reactions with cementitious mixtures, as well as avoiding hydrology problems that very often occur in the drying of cementitious mixtures. The cost of manufacturing suitable polypropylene fibers and other similar fiber materials has been justified by the final superior concrete products, as well as the reduction of other problems in the processing of concrete products.

Polypropylene and other similar fibrous materials used for concrete reinforcement are available in a wide variety of types, sizes and lengths. While adding substantial benefits to the final concrete or ceramic product, these fibers can be extremely difficult and time-consuming to accurately measure and dispense into the concrete and/or cementitious mixtures. The conventional method for dispensing fibers, such as polypropylene, into these mixtures is one small bag at a time. This is time-consuming and expensive.

This also raises safety issues since this operation must be done manually at the top of the dispenser. All too often, this entails an operator at the top of a ladder dumping small bags of fibers into large hoppers or mixers with moving parts. This is time consuming and expensive. The process can lead to other difficulties.

Some configurations of fibers tend to self-adhere in unusable clumps when improperly or awkwardly handled. Very often simple agitation by air currents will render such fibers unusable or detrimental to uniform dispersion. This is exacerbated by the fact the fibers are very sensitive to static electricity or simple mechanical manipulation, and have an immediate proclivity to intermingle and tangle (bridging). Even slight agitation may increase the amount of tangling exponentially. Thus, any type of mechanical handling of such fibers is always problematical.

Once fibers obtain such a condition, it is often impossible for them to become useful for dispersing uniformly in a cementitious or any mixture. Further, should such a clump of fibers be introduced to a cementitious or concrete mixture, the entire batch may become useless and have to be discarded. At the very least, the quality of the batch is greatly compromised.

Conventionally, low denier polypropylene fibers (typically used to reinforce concrete) are handled by being formed into “sticks”. Each “stick” is a predetermined length from ½ to 1½ inches, typically. This “stick” or bundle of fibers is typically between 1/32 and ¼ inch in diameter. The polypropylene “sticks” are typically transported in bulk, often in bags referred to as “super sacks” containing 200-800 pounds of product. The “sticks” must be measured accurately to determine precise weights in order to be properly applied for any use, especially cementitious or concrete mixtures. Typically, the polypropylene “sticks” disintegrate within the cementitious mixtures when applied at a particular point in the processing.

Unduly disturbed and tangled polypropylene “sticks” have a tendency not to disperse evenly. Virtually any interaction of the “sticks” with each other will cause the component polypropylene fibers to break loose and begin to tangle. This can result in the balling or clumping of fibers and substantial inaccuracies in the measurement of fibers to be applied to a particular use, such as a cementitious or concrete mixture. This, in turn, might result in failure of uniform fiber dispersion throughout the mixture, thus negating the enhancements to the concrete product, and even causing the concrete not to perform to its original level of design.

Conventionally, the handling of some fibers, including polypropylene fibers, for measurement to mixtures and other applications constitutes a major problem. Accordingly, there is a definite need for an accurate, simple, automatic system of handling polypropylene fibers (or other fibrous materials) for measurement to facilitate a wide variety of uses including addition to cementitious or concrete mixtures. Such a system would be simple to use, and would minimize the chances of clumping, bridging, or other adverse behavior for a variety of fibrous materials, including polypropylene. Fiber loss would be minimized, along with the time needed for any measuring and dispensing processes. Further, fibers could be added automatically in large amounts, or any amounts desired, without compromising operator safety, or requiring substantial efforts on the part of the operator.

### SUMMARY OF THE INVENTION

A primary object of the present invention is to overcome the drawbacks of the conventional art pertaining to the handling of fibrous materials.

It is an additional object of the present invention to provide a system for handling and dispensing dry bulk materials, including various fibers, such as polypropylene fibers, while minimizing material lost due to clumping or bridging.

It is another object of the present invention to provide a system in which any type of fiber or fibrous material can be quickly and easily handled, and accurately measured, minimizing adverse behavior, and hazards to operators.

It is a further object of the present invention to provide a system for handling fibers, including polypropylene fiber “sticks”, that avoids damage to the fiber “sticks”.

It is yet an additional object of the present invention to provide a system for fast, safe, efficient addition of a wide range of fiber types and amounts into a mixture.

It is still another object of the present invention to provide a system for handling polypropylene fiber “sticks” whereby fiber waste is substantially decreased, helping to ensure measuring accuracy.

It is again an additional object of the present invention to provide a system capable of uniform distribution of polypropylene fibers in a cementitious mixture, using a simplified automated mechanism, requiring reduced maintenance, and reduced operator effort.

These and other goals and objects of the present invention are achieved by a fiber dispensing system configured in a box-like casing with a top and bottom, and having at least one roller constituting the entire bottom of the box-like casing.

### BRIEF DESCRIPTION OF THE DRAWINGS

FIG. 1 is a side view of a generalized arrangement of one embodiment of the present invention.

FIG. 2 is a bottom view of the first embodiment of the present invention, in particular depicting the double roller structure.

FIG. 3 is a side view of a second embodiment of the present invention.

FIG. 4 is a bottom view of the second embodiment of the present invention, in particular, depicting the single roller structure.

FIG. 5 is a side view of a more detailed arrangement of the embodiment of FIG. 1.

FIG. 6 is a side view of a hopper used to facilitate the present invention.

FIG. 7 is a bottom view of the hopper of FIG. 6.

FIG. 8 is a front view of the hopper in an operational configuration of its sidewalls.

FIG. 9 is a front view of a roller that can be used in one embodiment of the present invention.

### DETAILED DESCRIPTION OF THE PREFERRED EMBODIMENTS

FIG. 1 depicts a system 10 for handling, dispensing, and measuring fibers and fibrous materials 200(a) (from Fiber Source 5) in a precise manner. This arrangement is particularly effective for handling polypropylene fiber “sticks” for accurate measurement and dispensing while avoiding damage to the fiber “sticks”. Other fibrous materials or packages (flakes, seeds, pellets, chips, kernels and the like) can also be handled by two inventive arrangements.

The fiber handling system or dispenser 1 is held in a casing or box-like structure 11, resting on a support structure 8. The fiber handling system 1 is includes hopper 2 for feeding material to the casing 11 and rollers arrangement 3 held in casing.

Support structure 8 can be any suitable structure with vertical supports to hold handling system 1. Collection area 4 is used to measure dispensed fibers 200(b). Any standard measuring or metering technique (including strain gauges, load cells and the like) can be used. The support structure 8 also provides support for a conveyance device 7, and a motivating device 6, such as a blower. Support structure 8 can also support additional dispensing or packing devices 9, or any number of often associated conventional devices.

Hopper 2 is supported by casing 11, and is used to receive various amounts of fiber or fiber “sticks” 200(a). Hopper 2 is not necessarily part of the present invention, but is an adjunct that can be used to facilitate the handling of various amounts of different types of fibers. Hopper 2, (FIG. 1) is depicted in a configuration which is efficacious for delivering polypropylene fiber “sticks” 200(a) to casing 11, for dispensing through rollers 3(a), 3(b). The walls of hopper 2 can be biased as depicted in FIG. 1 to help insure that there is no adhesion between fiber “sticks” 200(a) and the walls of the hopper. However, this is not a requirement for the invention. Rather, the hopper walls can have any kind of configuration, from the negative bias depicted to a positive bias. Further, the hopper 2 can be foreshortened along the longitudinal direction of rollers 3(a), 3(b) so as to keep fibers away from the latitudinal edges of the rollers, where they are supported by axles 31(a), 31(b).

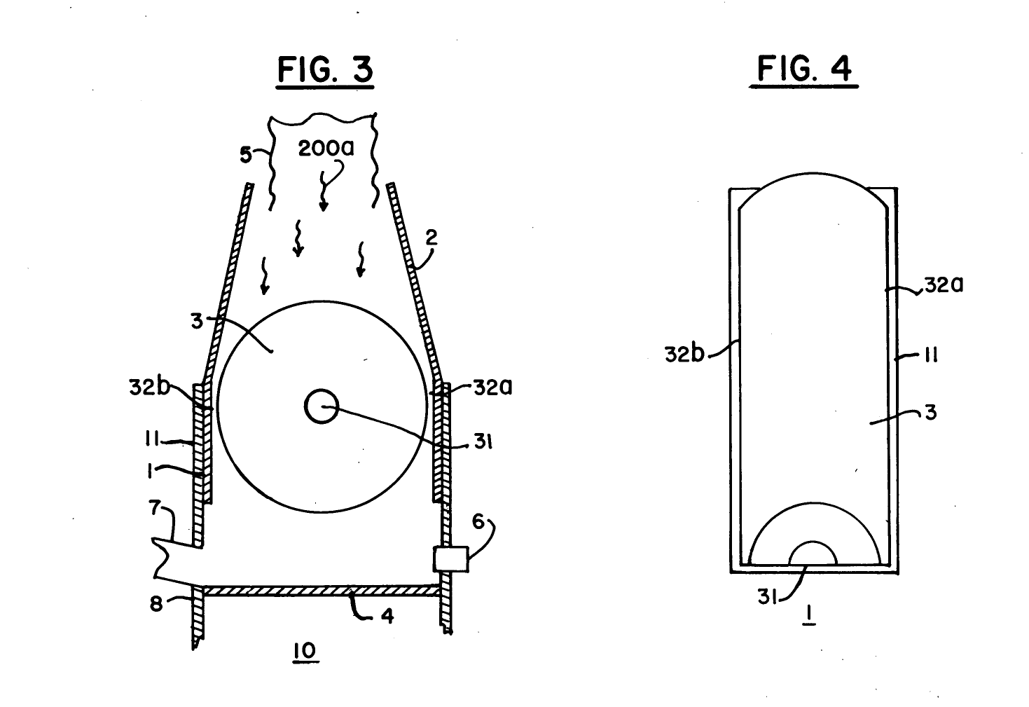

The rollers 3(a), 3(b) in casing 11 are used to timely dispense and effectively handle amounts of fiber “sticks” 200(a), or any other fiber materials or fiber like packages received from Hopper 2 for measurement and dispensing. The arrangement with the rollers 3(a), 3(b) and the casing 11, is such as to provide the capability of dealing with a wide variety of fiber types and fiber packages. This is done by adjusting the space 31 between the two rollers (or the spaces 32(b), 32(a) between the single roller and the framework as depicted in FIG. 3). This adjustability is carried out using any number of different conventional techniques. As a result, accommodation can be made for any number of fiber types or packages, including chips, seeds, flakes, pellets, sticks, and the like.

Fiber types that can be handled by the present invention range from steel filaments, to polypropylene fibers, to cellulose dice. The key attribute of the present invention is that the casing 11 has a bottom constituted solely by at least one roller (as depicted in FIG. 3), or multiple rollers such as 3(a), 3(b), as depicted in FIG. 1.

The purpose of the present invention is to handle fibers for measurement so that appropriate amounts of fibers or fiber packages, or other similar material can be measured out by automatic, mechanical means in bulk, for a particular application. Consequently, the precise size and spacing adjustment of framework 1, rollers 3(a), 3(b) and Hopper 2, will be determined in part by the type of fibrous materials and fiber packet configurations that are processed. Likewise, the type of measuring device (not shown) will be determined by the type of material being measuring. Measuring devices can be located in the casing 11, or at the rollers 3(a), 3(b), or any other convenient place.

Accumulation table 4 is particularly efficacious for measurement of fibers. Table 4 can be in any number of shapes. One shape that is currently in use is a “clam shell” arrangement that opens and closes. This can be done to package, protect and convey the measured fibers 200(b). This is a well-known conventional device.

The fiber “sticks” 200(a) can be transported in any number of different types of bags or other devices. One example is the use of the “super sack” or Gaylord transport sack, which contains 200-800 pounds of polypropylene fiber “sticks” 200(a). However, other sizes of bags or other transport devices can be used. Very often the fiber “sticks” 200(a), are somewhat compressed together and must be gently separated to avoid the natural interaction of the fiber “sticks” with each other. This can lead to additional problems.

One key attribute of the present invention is the smooth, simple structural arrangement that provides a minimum of opportunity for the polypropylene fiber “sticks” 200(a) (in either small or large quantities, even if compressed) to interact with system 10. This means that the fiber “sticks” can be separated gently while being agitated as little as possible. A major purpose of the present inventive system 10 is the measured distribution, by mechanical means, of particular amounts of fiber “sticks” 200(b) for use in particular applications, such as cementitious or concrete mixtures. The measuring or metering devices are not shown, but can be constituted by a wide variety of devices and techniques known in the fiber measurement art. These would include but not be limited to, timed measuring devices, spring scales, displacement devices, electronic load cells, strain gauges, or any other type of positive or negative measuring device. As such, further commentary regarding the measuring means is unnecessary for an understanding of the present invention.

Transport of the measured, accumulated fiber “sticks” 200(b) takes place from receiving propylene fiber “sticks” on accumulation table 4. The measured fiber “sticks” are handled or moved, after feeding, using any number of conventional devices and techniques, to the final application site. Preferably, with polypropylene “sticks” 200(b), movement is effected by a conveyor 7, such as an air transport system, motivated by a blower 6, or a differential pressure system (such as a vacuum system). However, mechanical conveyors can also be used, including belts, scoops buckets, augers and grasping hooks.

Differential pressure or air movement is preferred since this causes the least amount of agitation to the accumulated polypropylene fiber “sticks” 200(b), and so the least amount of “stick” disintegration with the harmful results inherent thereto. This system 10 will also protect or reduce damage to other types of fibers or fiber packages. It should be noted that different transport systems can be used, and may be more appropriate, for fibers other than polypropylene. For example, steel fibers are typically moved with a slatted conveyor.

The system 10 is built with a maximum of simplicity in order to minimize opportunities for interaction of fiber “sticks” (both fed 200(a) and accumulated 200(b)) from adversely interacting, disintegrating and causing fiber clumps. To that end, system 10 is formed with a box-like framework or casing 11 which preferably supports two rollers 3(a), 3(b), supported by axles 31(a), 31(b). This is done in a conventional manner, well known in the bearing support art. Preferably, the ends of the two rollers are kept positioned as close to casing 11 as possible in order reduce opportunities for the fibers 200(a) to interact in an adverse fashion.

The product to be dispensed and measured 200(a) is introduced as close to the tops of rollers 3(a), 3(b) as possible. A very short path from the tops of the rollers 3(a), 3(b) to opening 32 (between the rollers) allows fibers 200(a) to move quickly between the two rollers 3(a) and 3(b), using just the force of gravity. It should be noted that while the force of gravity is used in the FIG. 1 embodiment, other conventional means (such as vibrators, pressure differentiation, static charging, and blown air, as well as hopper configuration) can be added to further facilitate the movement of fibers 200(a) above the rollers.

A key attribute in the configuration of dispenser 1 resides in keeping the structure as simple as possible, and thus, as free of possible collection points for polypropylene fiber “sticks” as possible. The configuration of all of the dispenser 1, casing 11, hopper 2, and rollers 3(a), 3(b) must be made in a manner that avoids any type of structural characteristic that either agitates polypropylene fiber “sticks”, or provides a convenient resting place for the “sticks” to congregate.

The polypropylene fiber “sticks” 200(a), or individual fibers in loose form, or collated fibers, are moved between the two rollers, 3(a), 3(b), compressing them somewhat as they are moved. The compression helps to facilitate efficient movement of “sticks” 200(b) below the rollers. The space 32 between the two rollers is adjusted to between ¼ inch and 3 inches for the type and size of fiber “sticks” or fiber material to be used in order to expedite movement of the polypropylene fiber “sticks” there through. It should be understood that opening 32 can be adjusted for other types of fibers, and fibrous materials such as flakes, chips, seeds, pellets, and the like. Opening 32 can be adjusted to change the rate of fiber flow during the metering process. This can be accomplished in a conventional manner by adjusting axles 31(a), 31(b). One example would be the use of air cylinders to make the adjustment in the subject axles during the metering cycle. The axles can also be adjusted to close opening 32, if desired.

The rollers 3(a) and 3(b) are smooth in the FIG. 1 embodiment so as to expedite movement of the polypropylene fiber sticks 200(a) without causing damage to them. It is understood that broken fiber sticks or clumped fibers can be disastrous in the final concrete product. However, the rollers need not be entirely smooth, but can include air holes to accommodate differential pressure or blown air capabilities. Also, very smooth indentations can be formed in the rollers in order to facilitate the action of the rollers on the fiber “sticks” 200(a). In the FIG. 1 embodiment, any number of different smooth indentation patterns can be used to facilitate fiber “stick” and individual or collated fiber movement.

The rollers 3(a), 3(b) are preferably made of steel pipe or other sound material (such as plastic or wood) in the FIG. 1 embodiment. Preferably, the rollers are interchangeable, and different types of rollers can be installed for different types of fibers and fiber packages. In the alternative, wood rollers or plastic rollers can be used.

A crucial improvement of the present invention is that with a casing 11 having a bottom constituted only by a moving roller 3 or rollers 3(a), 3(b), the amount of fiber loss is substantially less than with conventional polypropylene fiber “sticks” measuring and handling systems. One key attribute of the present invention is that the use of rollers results in a very short path between the beginning and the end of the handling process. The fibers are dispensed at right angles, more or less, to the longitudinal axes of the rollers, resulting in lessening fiber disturbance. Further, because the structure of the rollers and casing 11 is symmetrical (can be used in either direction just as effectively), it is not only cheaper, but more versatile.

In the FIG. 1 embodiment the rollers 3(a), 3(b) rotate at a speed of approximately 10 rpm. The rollers rotate toward the space between them 32 as indicating in FIG. 1. It should be noted that the rollers may move more slowly than 10 rpm, or much faster. At a speed of 100 rpm, for example, the rollers will create a new dynamic situation because of the rotational forces created. This has to be adjusted very carefully for the type of fiber to used by the fiber handling and measuring system 100.

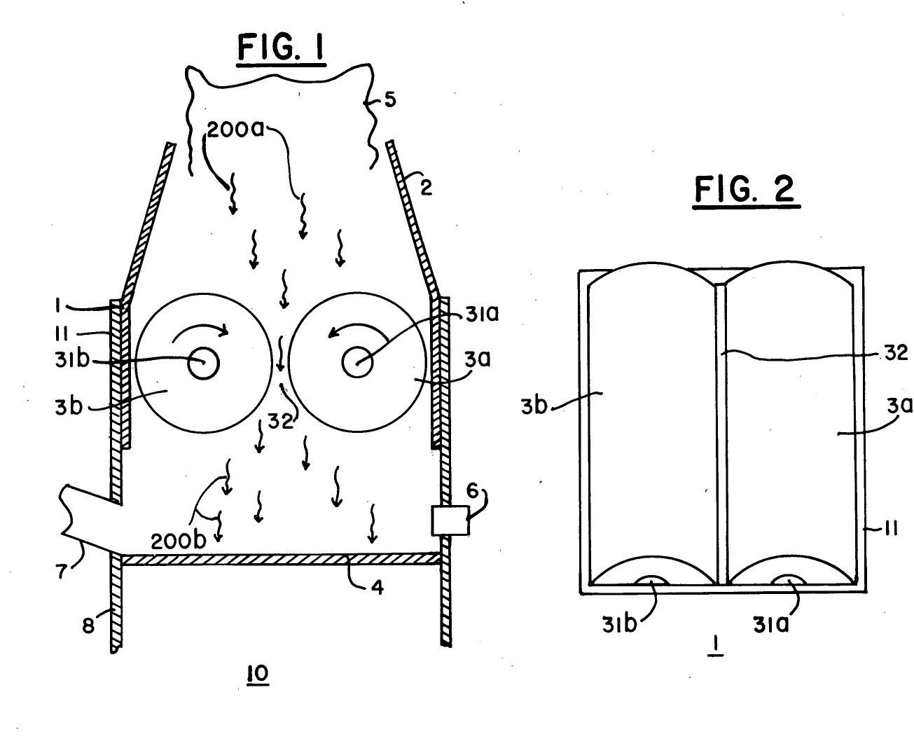

While smooth rollers 3(a) and 3(b) are depicted in FIG. 1 and FIG. 2, other roller surfaces can be used. The configuration of teeth, hooks, screw-like spirals or other roller surfaces can be adjusted for the particular type of fiber used. Likewise, the speed of the rollers can be adjusted to accommodate a number of different situations, including the original density of the packed fiber “sticks” 200(a), the type of fiber, the density of the fibers, and the like. Accordingly, any configuration of roller surface can be used within the concepts of the present invention.

In the embodiments depicted by the FIGS. 1-4, smooth roller surfaces are used. However, this need not be the case for operation within the concept of the present invention. Another embodiment includes the use of additional structures on the surface of the rollers. For a typical roller having a 3-6 inch diameter and a 15 inch length, a spiral of plastic material can be placed on the surface to facilitate fiber movement. The spiral would be of an unconfigured plastic material, approximately 1 inch high and 1 inch wide. There would be an approximately 4 inch pitch. In the alternative, the material on the spiral could be configured a manner most appropriate for a particular material to be handled.

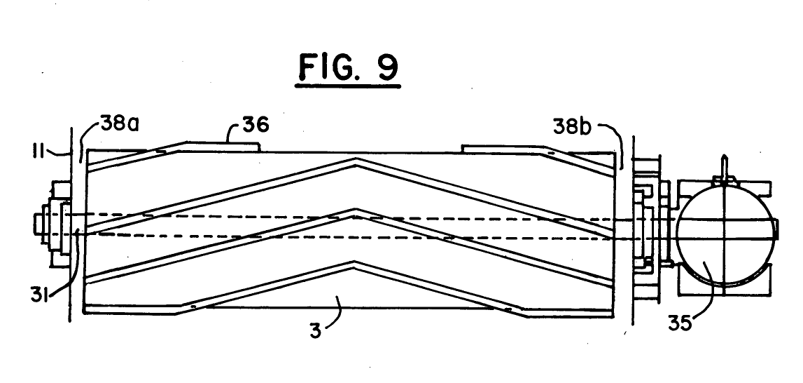

One particular roller configuration that is particularly effective with polypropylene fibers is depicted in FIG. 9. The roller 3 is shown as it extends its entire length within casing 11. The roller 3 is rotated by a motivating system 35 on axle 31. Of greatest interest are plastic ridges 36 which are placed upon roller 3 in a configuration approximating a double or diagonal spiral. For use with polypropylene fibers, the ridge material is preferably made of plastic. However, other materials, such as wood, can be used. Further, while the configuration of the ridges is depicted as straight lines in two opposite diagonal patterns, other patterns can be used within the concept of the present invention. Such adjustment would be based upon the size, weight and other characteristics of the materials to be handled.

The receiving table 4 can be used to measure the amount of fiber 200(b) being allocated for use. It can include load cells, doors, blowers and the like, as well as measuring systems. The measuring devices (not shown) can be built into receiving table 4, as well as the box-like roller support framework 1. Measurement of fibers 200(b) is facilitated by the smooth, even movement of fibers past rollers 3(a), 3(b). Once fibers have begun to clump or bridge, accurate measurement of fiber amounts becomes extremely problematical. The present invention prevents this situation from occurring.

A key attribute of the present invention is to the make the path of travel of the fibers from opening 32 to holding chamber 4 as short as possible. In some cases, this can be made as little as one inch. It has been found that smooth movement of fibers 200(a) is far better facilitated by the short path from the top of rollers 3(a), 3(b) to opening 32 and the area above receiving table 4. This arrangement avoids clumping or bridging very often associated with polypropylene fibers. Consequently, rollers 3(a) and 3(b) will be located to be as close to the receiving table 4 as possible, and constitute the entire bottom of box-like casing 11. The overall result is decreased loss of fibers compared to conventional handling/measuring systems.

Because the casing 11, holding rollers 3(a), 3(b) is symmetrical and simple, it can be easily rotated in a carousel-like arrangement (not depicted) so as to service a series of different feeding and receiving arrangements. Each of the feeding and receiving arrangements would be used for handling different types of fibers. The capability of the present invention to be adjusted, and for rollers to be changed to achieve different roller configurations would facilitate such an arrangement.

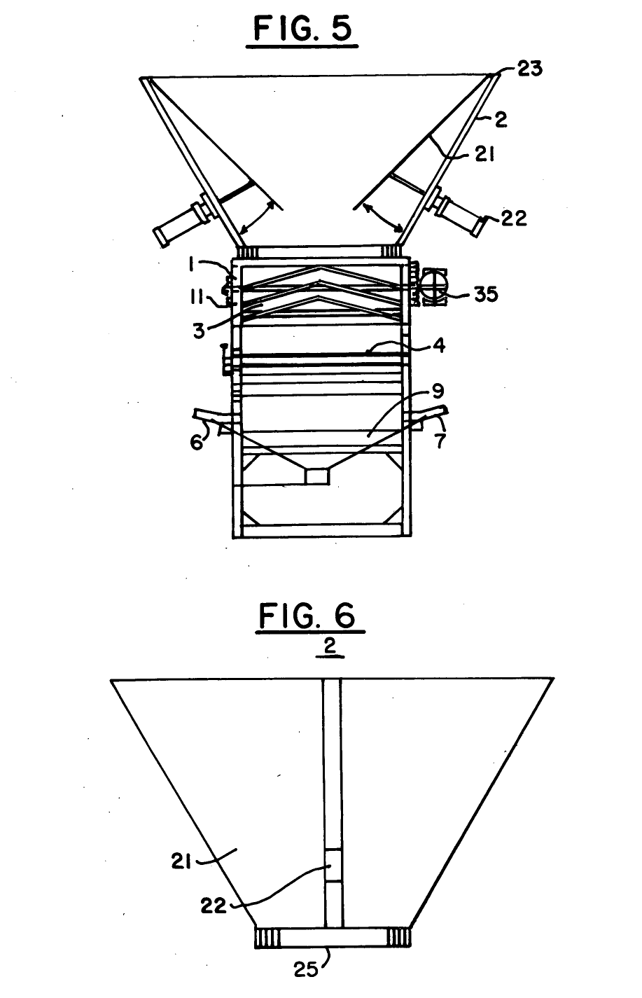

FIGS. 5-8 depict a hopper 2 that is configured to be particularly effective with polypropylene fibers. As previously discussed, polypropylene can be particularly difficult to work with, often resisting movement in desired vectors, and at worst clumping into unusable masses. In the instant application, the object is to move polypropylene fibers through the space 32 (FIG. 1) between the two rollers 3(a), 3(b) in the most expeditious manner possible. Unfortunately, polypropylene fibers tend to clump at intersections or interfaces between surfaces, even such interfaces as that between the hopper 2 and casing 11 (in FIG. 1).

It has been found that by swinging or rotating the bottoms of sidewalls 21 upwards and towards the middle of hopper 2, that an easy movement of polypropylene fibers can be effective towards the space 32 between rollers 3(a), 3(b). In the case of a single roller system (as depicted in FIGS. 3 and 4), the moving sidewall 21 can be aligned to guide the fibers to either space 32(a) or 32(b). However, it has been discovered that when using polypropylene fibers, a dual roller configuration, (such as that of FIG. 1) is most efficacious.

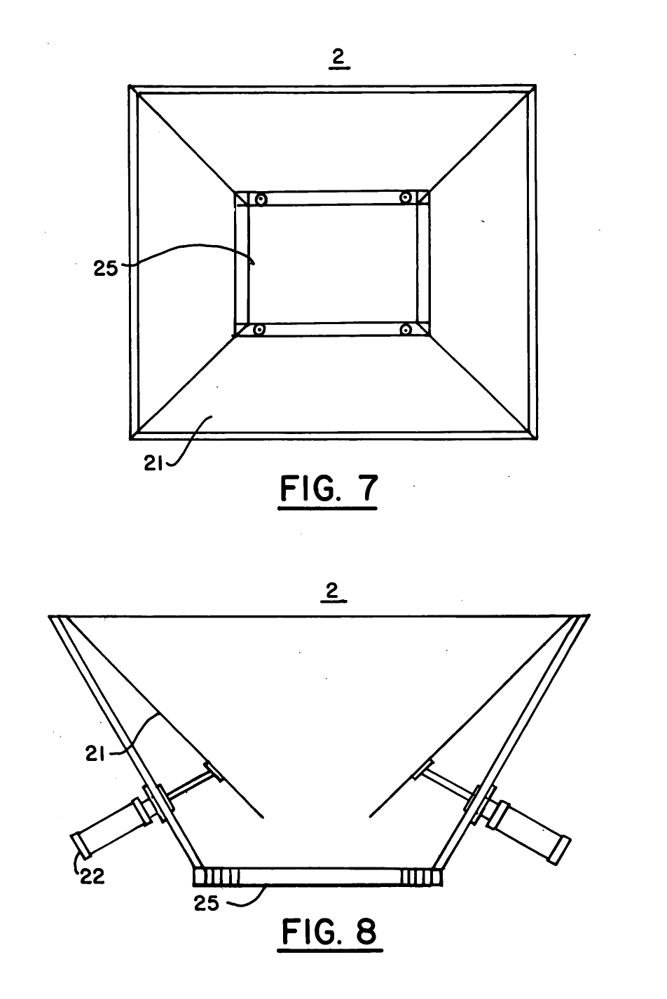

In the drawings, sidewalls 21 are rotated from the bottom up by motivating systems 22. The sidewalls rotate on hinge-like structures 23 at the top of hopper 2. While the drawings depict sidewalls 21 as swinging along the longitudinal axis of roller 3, the system can be configured so that the sidewalls swing perpendicular to the longitudinal axis of roller(s) 3. This configuration has proven most effective for polypropylene fiber “sticks”. It should be noted that all of the sidewalls 21 can be configured to move in various ways in order to best facilitate the movement of fibers in a desired direction. Accordingly, all four of the sidewalls 21 can have various types of motivating means, and can be hinged to move in different directions. Also, while the bottom aperture 25 in hopper 2 is shown as a rectangle in FIG. 7, other shapes can be used to help direct the flow of the fibers being processed.

While a number of embodiments and variations have been provided by way of example, the present invention is not limited thereto. Rather, the present invention should be construed to include any and all variations, permutations, adaptations, derivations, and embodiments that would occur to one skilled in this art once having been taught the present invention. Accordingly, the present invention should be limited only by the following claims.

I claim:

1. A fiber dispensing system configured in a box-like casing with a top and a bottom, said casing containing at least one roller constituting an entire bottom of said casing.

2. The fiber dispensing system of claim 1, further comprising two rollers with space there between.

3. The fiber dispensing system of claim 2, further comprising motivating means to rotate said rollers in opposite directions toward each other and towards and upper portion of said casing.

4. The fiber dispensing system of claim 3, further comprising a feeder located above said casing, and arranged to pass product to said casing.

5. The fiber dispensing system of claim 4, wherein said feeder comprises a plurality of slanted side walls.

6. The fiber dispensing system of claim 5, wherein said feeder comprises four slanted side walls.

7. The fiber dispensing system of claim 6, wherein at least one of said side walls is arranged to move in a manner to facilitate product movement from said hopper to said rollers.

8. The fiber dispensing system of claim 7, wherein at least one said side wall rotates in a direction perpendicular to a longitudinal axis of said rollers.

9. The fiber dispensing system of claim 8, wherein at least two said side walls rotate towards each other.

10. The fiber dispensing system of claim 9, wherein four side walls are arranged to move in a manner facilitating movement of product between said rollers.

11. The fiber dispensing system of claim 2, wherein said rollers have smooth surfaces.

12. The fiber dispensing system of claim 2, wherein said rollers comprise ridges formed on said rollers surfaces.

13. The fiber dispensing device of claim 12, wherein said ridges are configured diagonally along said surface of said rollers.

14. The fiber dispensing device of claim 13, wherein said ridges comprise multiple spirals.

15. The fiber dispensing system of claim 14, wherein said ridges extend substantially one inch above said surface of said rollers, and are substantially one inch in width.

16. A method of dispensing fibers:
(a) shifting moveable walls; and,
(b) rotating rollers through which fibers pass.
